(19) United States
(12) Patent Application Publication
(10) Pub. No.: US 2005/0174604 A1
(43) Pub. Date: Aug. 11, 2005

(54) Method and apparatus for assembling postal items

(76) Inventor: Jelle Wiersma, Drachtster Compagnie (NL)

Correspondence Address: PERMAN & GREEN, 425 POST ROAD, FAIRFIELD, CT, 06824, US

(21) Appl. No.: 11/026,262

(22) Filed: Dec. 31, 2004

(30) Foreign Application Priority Data
Dec. 31, 2003 (NL) 1025163

(51) Int. Cl. G06F 15/00

(52) U.S. Cl. 358/1.18; 358/1.12

(57) ABSTRACT

Prior to assembling postal items of which at least a number each comprise a main document (2) and at least one annex (4, 5, 6) of at least one type, one or more mini-image files (23, 24,2 5) are stored, each defining a representation (26, 27, 28) of a part of a type of annex (4, 5, 6). On each main document (2) for a postal item (1) including the at least one type of annex (4, 5, 6) for one or each of a number of the annexes, the representation of the respective annex (4, 5, 6) defined by the mini-image file (23, 24, 25) is printed.

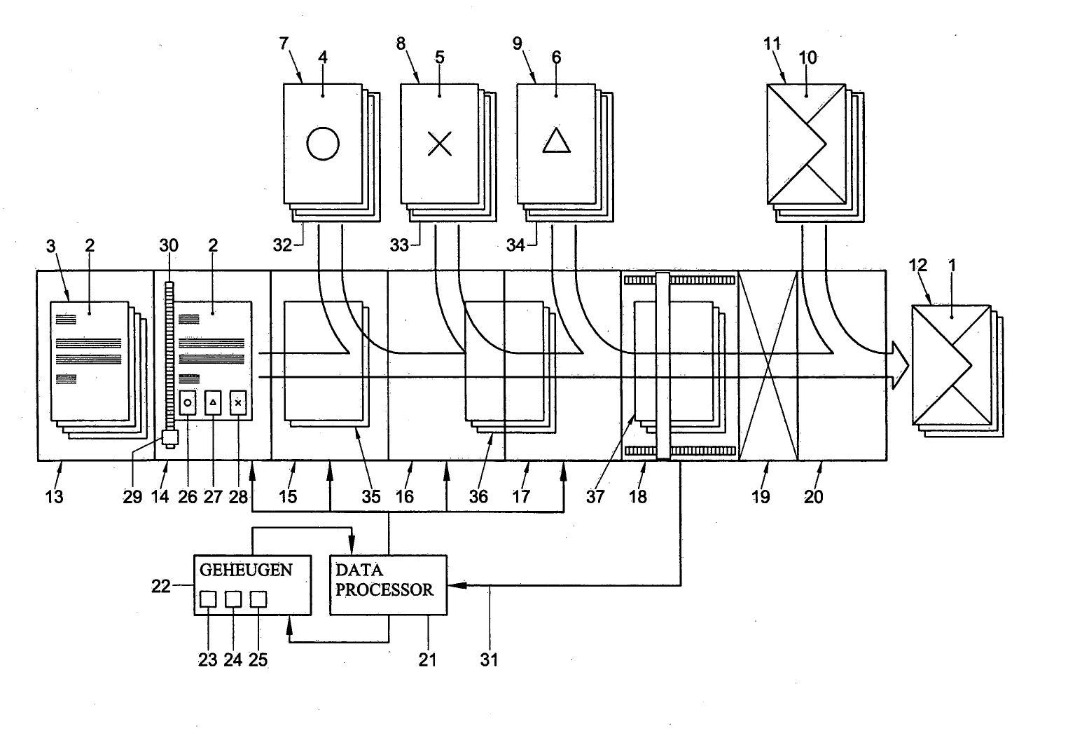

### FIELD AND BACKGROUND OF THE INVENTION

The invention relates to a method and an apparatus for assembling postal items.

When assembling postal items, in many cases, main documents are assembled with annexes to form a set, which set is then finished into a postal item, for instance by enveloping it or packaging it in a different manner.

The main document can for instance be a unique document intended for the addressee, such as a bill, a statement of account or an insurance policy overview. The main document can also be a document which, apart from optionally an address, also contains information about the content of the postal item, such as a cover of a magazine. The main document can also form the covering of the annexes and, optionally, a further main document, and be designed, for instance, as an envelope in which the annexes are sent.

One objective of (marketing) communication by means of adding annexes is that as much note as possible is taken of the contents of these annexes, in particular by persons potentially interested therein. In these and other cases, it is desirable that it is indicated on the main document which annexes the postal item contains, so that the annexes are less easily accidentally thrown away.

An occurring problem here is that the indications of the annexes on the main document are to be logistically geared to the available annexes and the number of annexes to be sent along.

### SUMMARY OF THE INVENTION

It is an object of the invention to simplify the provision of indications of annexes included in postal items.

According to the invention, this object is achieved by providing a method according to claim 1. The invention also provides an apparatus according to claim 8 which is specifically designed for carrying out the method according to claim 1.

As representations of an annex of the type which has, or the types which have been added to a main document are printed on the main document, the main documents are provided in a very simple manner with indications of annexes and these indications can be geared very simply and flexibly to the annexes to be sent along without editing of the main document being required.

Further elaborations of the invention are described in the dependent claims.

Further design aspects, effects and details of the invention appear from the detailed description of an exemplary embodiment with reference to the drawing.

### BRIEF DESCRIPTION OF THE DRAWING

The drawing shows a schematic representation of the process of carrying out an example of a method according to the invention by means of an example of an apparatus for assembling postal items.

### DETAILED DESCRIPTION

The postal items 1 which are assembled according to the example described hereinafter comprise one or more main documents 2 which are supplied from a stack 3 and annexes 4, 5, 6 of three different types which are each dispensed from a stack 7, 8, 9, and envelopes 10 which are dispensed from a stack 11. The stacks 3, 7, 8, 9 and 11 are loaded in dispensing holders 32, 33, 34, such as paper cassettes, by a user of the apparatus. The ready postal items are assembled to form a stack 12. The main documents are sent to all addressees and can all be identical or be different for a number of the addressees or for each addressee.

The apparatus for assembling postal items according to the example represented in the drawing has, as stations, a dispensing station 13 for dispensing main documents 2 from the stack 3 one by one, a printer 14, three annex supply stations 15, 16, 17, a scanner 18 and, as finishing stations, a folding station 19 and an enveloping station 20 for finishing the assembled set of documents to form postal items. It is noted that for the sake of convenient organization, the stacks of documents 7-9 and the stack of envelopes 11 have been depicted next to the annex supply stations 15-17 and 20 but that as a rule, in practice, they will preferably be located in line with a conveying path extending along or through the stations 13-20.

The apparatus further comprises a data processor 21 for controlling the apparatus and a memory 22 coupled to the data processor 21, so that the data processor 21 can store data in the memory 22 and read data therefrom. The data processor can, for that matter, also be designed as a structure of cooperating processors that can be mounted in a joint housing or, in part or not in part, in separate housings.

The data processor 21 and the memory 22 are designed for storing mini-image files 23-25, each defining a depiction of at least a part of an annex 4-6 of a particular type.

The data processor 21 and the printer 14 are designed for printing one or more representation(s) 26, 27, 28 defined by one or more of the mini-image files 23-25 on each main document 2 intended for a postal item with one or more annexes. According to the example represented in the drawing, annexes of all three types 26, 27, 28 are to be added to the document 2 present in the printer 14. Accordingly, representations of parts of each of the three types of annexes 4, 5, 6 have been printed by the printer 14, a printer head 29 of which being reciprocally moveable along a rail 30.

Thereupon, in the annex supply stations 15, 16, 17, for assembling the main document 2 and the annexes 4, 5, 6 to form a set, each time one copy of these annexes is added to the main document, until the set of sheets 35, 36, 37 to be finished to form a postal item is complete.

Finishing the set of sheets 35, 36, 37 to form a postal item is then carried out, insofar as required, by folding in the folding station 19 and by enveloping in the enveloping station 20.

In this manner, on each main document 2 intended for a postal item 1 with one or more annexes 4, 5, 6 of the three types of annexes loaded in the annex supply stations 15, 16, 17, one or more representations 26, 27, 28 defined by the associated mini-image files 23, 24, 25 are printed. As representations of the annexes 4, 5, 6 or parts thereof are used as annex indications, the main documents can be provided with indications about the annexes in a very simple manner, in a mail room, and without editing the main document itself, or without essential knowledge of the content or meaning of the annexes 4, 5, 6. Thus, also in cases in which establishing the annexes to be sent along is not done, at least partly, when the main document is drafted (as is the case when advertisements are sent along with bills and the like or magazines, or annexes are added to a franking value threshold) the main document can be provided with indications relating to the annexes, without re-editing of the main document being required.

It is possible to print as representation a part of the annex in full size or larger. However, in general, it is more advantageous to print a reduced representation of the entire annex of a particular type, or of a characterizing part thereof, because thus, in a relatively reliable manner, a depiction is obtained that fits on the main document and by which the recipient can tell which annex is involved and on the basis of which the recipient can simply recognize the respective annex. The representation printed as annex indication can also be a line or part of a line of a text of the respective annex. The representation printed as annex indication is each time the same for all annexes of a particular annex type.

The invention can be used in situations in which all postal items manufactured during one “run” or “job” are to contain the same types of annexes, but is also particularly suitable for providing annex indications on the main documents when particular annexes of the available types of annexes are to be selectively added to particular main documents, depending on sets of annex instructions associated with a main document. Such annex instructions can for instance appear, by reference or not by reference, from machine-readable signs on the main documents or be presented synchronized with the main documents, which is attractive in particular if the main documents are printed in-line, i.e. are dispensed one by one by the printer that prints the documents, to the stations for assembling postal items.

For printing on each main document, automatically and selectively, only those representations of the types of annexes that correspond with the annex types which, according to the annex instructions, are to be added to the respective main document, mini-image files 23-25 are stored, each in association with an indication identifying the respective type of annex 4, 5, 6. The indication can consist of, for instance, a code identifying the annex supply station 15, 16, 17 in which the annexes 4, 5, 6 of the respective type have been loaded, or an annex identification code. This latter can for instance form part of the instructions associated with the series of postal items to be manufactured.

When assembling the postal items 1, in accordance with the annex instructions, the mini-image files 23-25 are selected which are identified by the indications of the type of annex 4-6 which, according to the annexe instructions, is intended for the same postal item as the main document 2 with which the annex instructions are associated. It is possible that then only one or no annex is added to some of the main documents, in which case for that main document one or no mini-image file 23-25 is selected.

Then, the data processor 21 ensures the printer 14 being controlled for exclusively printing those representations 26-28 which are defined by the selected mini-image files 23-25.

As the annex supply stations 15-17 are accordingly controlled for selectively adding, in accordance with the annex instructions, annexes 4-6 of the type loaded in the controlled annex supply stations 15-17, exclusively to main documents 2 for which annexes of this type are intended according to the annex instructions, it is achieved that the main documents 2 are each exclusively provided with representations of those types of annexes 4-6 which form part of the postal item 1 the main document forms part of.

Printing the representations and printing the main documents can be carried out simultaneously. When the main documents are then dispensed, one by one, by the printer to the stations for, each time, assembling the sheets belonging to a postal item and for finishing the postal item, at the last moment, when printing the representations, the presence of annexes, modifications in annexes and/or the choice of annexes can be taken into account.

However, according to the present example, printed main documents 2 are supplied to the printer 4 and printing the representations 26-27 of annexes 4-6 defined by the mini-image files 23-25 is carried out by printing on the printed main documents 2. As a result, also when processing main documents which have been printed in advance, it is possible to adjust the annex indications in a flexible manner, and until the last moment, in accordance with the presence of annexes, modifications in the annexes and/or the choice of annexes et cetera.

The apparatus according to this example is equipped with a scanner 18 for scanning at least one annex 4-6 of a particular type. Here, via a connection 31, the data processor 21 is coupled to the scanner 18, and designed for converting signals obtained upon scanning into the mini-image files 23-25. As the mini-image files 23-25 are obtained by scanning the annexes 4-6 of the respective types and converting signals obtained upon scanning into the mini-image files 23-25, it is ensured in a simple manner that the correct representations 26-28 are printed on the main documents 2, without it being required that mini-image files 23-25, or information on the basis of which these can be assembled, are supplied.

According to this example, further, the scanner 18 is located downstream of the holders 32-43 of the annex supply stations 15-17 for dispensing the annexes 4-6 one by one. The data processor 21 is further designed for controlling the annex supply stations 15-17 for dispensing, during a start-up phase, a copy of the annexes 4-6 from the holders 32-43 into the holders 32-34, receiving signals obtained upon scanning of the annex 4-6 of the types loaded in the annex supply stations 15-17, and storing the mini-image file 23-25 in association with at least one annex supply station code of the annex supply station 15-17 controlled for dispensing the scanned document, which annex supply station code indicates to which of the annex supply stations 15-17 the mini-image file belongs.

In this manner, the mini-image files 23-25 are not only obtained during scanning, but what is also achieved during the start-up phase prior to the operational phase is that the mini-image files 23-25 are automatically coupled to the annex supply stations 15-17 in which the respective annex types 4-6 have been loaded. When, in operation, the annex instructions indicate, for instance, that annexes 4, 5 from the first two annex supply stations 15, 16 are to be added to a particular main document, on the basis of the annex instructions, also the mini-image files with the codes identifying the first two annex supply stations 15, 16 are selected, resulting in the printing of the representations 26, 28 of the annexes 4, 5 on the main document in the first two annex supply stations 15, 16

However, the mini-image files can also be obtained in many different manners, for instance from the designer or printer of the respective annex. During a start-up phase preceding an operational phase during which postal items are assembled, the scanner 18 can be utilized for recognizing the annex types to which the documents dispensed by the annex supply stations 15, 16, 17 belong. What can be achieved when the mini-image files 23-25 are stored in association with indications referring to associated annex types is that automatically, the correct annexes are added and the correct mini-image files are printed.

When the scanner 18 is used only during the start-up phase, it is advantageous to design it to be removable. A relatively slow scanner then suffices, scanning the annexes only during the start-up phase, because during the operational phase, the documents and annexes do not need to be led through the scanner.

The annexes can also be printed in reaction to annex instructions which refer to particular types of annexes, while each time, those mini-image files for determining the representations to be printed on the main documents are selected that belong to the annex types indicated by the annex instructions.

1. A method for assembling postal items, of which at least a number each comprise one main document (2) and at least one annex (4, 5, 6) of at least one type, comprising:
storing a mini-image file (23, 24, 25) for at least one type of annex, which mini-image file (23,24, 25) defines a representation (26, 27, 28) of at least a part of that type of annex (4, 5, 6):
printing on each main document (2) for a postal item (1) comprising at least one type of annex (4, 5, 6) the at least one representation (26, 27, 28) defined by the respective at least one mini-image file (23, 24, 25); and
assembling the main documents (2) and the annexes (4, 5, 6) to form sets and finishing them into postal items (1).

2. A method according to claim 1, wherein the mini-image files (23, 24, 25) each define a reduced depiction (26, 27, 28) of at least a part of a type of annex (4, 5, 6).

3. A method according to claim 1, wherein annex (4, 5, 6) instructions for each postal item (1) selectively define which at least one type of annex (4, 5, 6) is associated therewith, and wherein storing the at least one mini-image file (23, 24, 25) is carried out in association with an indication identifying the respective type of annex (4, 5, 6), further comprising:
selecting, for at least a number of the main documents (2), in accordance with associated ones of the annex instructions, at least one of the mini-image files (23, 24, 25); and
printing on each of said number of main documents (2) the at least one representation (26, 27, 28), defined by the at least one selected mini-image file (23, 24, 25), of the at least one associated type of annex (4, 5, 6).

4. A method according to claim 1, further comprising supplying printed main documents (2) to a printer (14), while printing the at least one representation (26, 27, 28) defined by the respective at least one mini-image file (23, 24, 25) is carried out by printing on the printed main documents (2).

5. A method according to claim 1, further comprising scanning at least one annex (4, 5, 6) of a particular type.

6. A method according to claim 5, further comprising the conversion of signals obtained while scanning into at least one of said mini-image files (23, 24, 25).

7. A method according to claim 5, further comprising loading the annexes of the at least one type in a holder (32, 33, 34) of at least one annex supply station (15, 16, 17) for one by one dispensing from a holder (32, 33, 34) annexes (4, 5, 6) for a set of sheets to be formed into a postal item (1) and for dispensing, during a start-up phase prior to an operational phase during which postal items (1) are assembled, one copy of at least one of the annexes (4, 5, 6) in said at least one holder (32, 33, 34), while scanning the at least one annex (4, 5, 6) of the at least one type loaded in the at least one holder (32, 33, 34) is carried out by scanning the at least one dispensed copy.

8. A method according to claim 7, further comprising storing at least one mini-image file (23, 24, 25), obtained starting from the at least one scan result, in association with an annex supply station code representing the annex supply station (15, 16, 17) controlled for dispensing the respective scanned annex (4, 5, 6) and selecting, during operation, said at least one mini-image file (23, 24, 25) for printing representations defined thereby in accordance with annex instructions referring to the annex supply station code which represents the annex supply station code associated with the respective mini-image file (23, 24, 25).

9. A method according to claim 7, further comprising:
comparing the at least one scan result to at least one annex reference associated with a particular annex type;
associating, in reaction to a particular minimum degree of correspondence, an annex supply station code, representing the annex supply station (15, 16, 17) controlled for dispensing the respective scanned annex (4, 5, 6), with the at least one annex type to which the at least one annex reference belongs; and
selecting, during operation, in accordance with annex instructions which refer to the respective annex type, at least one mini-image file (23, 24, 25) belonging to the particular annex type, for printing the at least one representation defined thereby.

10. An apparatus for assembling postal items, of which at least a number each comprise a main document (2) and at least one annex (4, 5, 6) of at least one type, comprising:
a memory for storing at least one mini-image file (23, 24, 25) defining a representation (26, 27, 28) of at least a part of an annex (4, 5, 6) of a particular type;
a data processor structure (21) and a printer (14) for printing on each main document (2) for a postal item (1) comprising the at least one type of annex (4, 5, 6) the at least one representation (26, 27, 28) defined by the respective at least one mini-image file (23, 24, 25);
at least one annex supply station (15, 16, 17) for each time assembling at least one main document (2) and an annex (4, 5, 6) to form a set (35, 36, 37); and
at least one finishing station (19, 20) for finishing said sets (35, 36, 37) to form a postal item (1).

11. An apparatus according to claim 10, wherein the data processor structure (21) is designed for:
storing the at least one mini-image file (23, 24, 25) in association with an indication identifying the respective type of annex (4, 5, 6);
selecting for at least a number of the main documents (2), in accordance with associated ones of the annex instructions which selectively define annexes for the postal items (1), at least one of the mini-image files (23, 24, 25) identified by the at least one indication of the at least one type of annex (4, 5, 6) which, according to the annex instructions (4, 5, 6), is intended for the same postal item (1) as the respective of the main documents (2);
controlling the printer (14) for printing exclusively those representations (26, 27, 28) which are defined by the at least one selected mini-image file (23, 24, 25); and
controlling the at least one annex supply station (15, 16, 17) for selectively adding, in accordance with the annex instructions, annexes (4, 5, 6) of the type loaded in this annex supply station (15, 16, 17) exclusively to main documents (2) for which, according to the annex instructions, annexes (4, 5, 6) of this type are intended.

12. An apparatus according to claim 10, further comprising a scanner (18) for scanning at least one annex (4, 5, 6) of a particular type; the data processor structure (21) being further designed for converting signals obtained upon scanning into at least one of said mini-image files (23, 24, 25).

13. An apparatus according to claim 12, wherein the scanner (18) is located downstream of a holder (32, 33, 34) of an annex (4, 5, 6) supply station (15, 16, 17) for one by one dispensing annexes (4, 5, 6) for a set (35, 36, 37) of sheets to be processed to form a postal item (1) and wherein the data processor structure (21) is further designed for controlling the annex supply station (15,16, 17) for one by one dispensing annexes (4, 5, 6) for dispensing, during a start-up phase, one copy of at least one of the annexes (4, 5, 6) into said holder (32, 33, 34), for receiving signals obtained upon scanning of the annexes (4, 5, 6) and storing at least one mini-image file (23, 24, 25) in association with at least one annex supply station code which indicates with which annex supply station (15, 16, 17) the mini-image file (23, 24, 25) is associated.
